(19) United States
(12) Patent Application Publication
(10) Pub. No.: US 2014/0109890 A1
(43) Pub. Date: Apr. 24, 2014

(54) Electrolyte Formulations For Oxygen Activated Portable Heater

(71) Applicant: Rechargeable Battery Corporation, College Station, TX (US)

(72) Inventors: Christopher Pedicini, Nashville, TN (US); Wesley Pedicini, Nashville, TN (US); Adam Laubach, Kingwood, TX (US); Darko Marquez, College Station, TX (US); Lawrence Tinker, Bryan, TX (US)

(21) Appl. No.: 14/058,719

(22) Filed: Oct. 21, 2013

Related U.S. Application Data
(60) Provisional application No. 61/716,226, filed on Oct. 19, 2012.

(51) Int. Cl. F24J 1/00; B23P 19/00

(52) U.S. Cl. CPC F24J 1/00; B23P 19/00
USPC 126/263.02; 29/428

(57) ABSTRACT

An oxygen based heater and various electrolyte solution formulations for same wherein the boiling point and/or relative humidity of the electrolyte solution are used as a determining basis for using that electrolyte solution in the heater.

### CROSS REFERENCE TO RELATED APPLICATIONS

This application claims priority to U.S. Provisional Patent Application No. 61/716,226 filed on Oct. 19, 2012, the entirety of which is incorporated herein.

### FIELD OF THE INVENTION

The invention relates to a heater that uses mostly atmospheric oxygen as a fuel source for a reaction that produces heat and more specifically to various electrolyte formulations for same.

### BACKGROUND OF THE INVENTION

Portable flameless heaters are currently used in a variety of applications, such as heating comestible items.

For example the United States Army uses a flameless ration heater (FRH) rather than a portable camp stove to heat a pre-packaged MRE (meal ready to eat) eight-ounce (approximately 227 grams) field ration. The FRH consists of a super-corroding magnesium/iron mixture sealed in a waterproof pouch (total FRH weight is approximately 22 grams). To operate a FRH, the pouch is opened into which the MRE is inserted, and approximately 58 grams of water is added to a fuel-containing portion of the FRH pouch surrounding the MRE to initiate the following reaction:

Mg+2H₂O→Mg(OH)₂+H₂

Based upon the above reaction of the fuel, the MRE temperature is raised by approximately 100° F. in less than 10 minutes. The maximum temperature of the system is safely regulated to about 212° F. by evaporation and condensation of water vapor.

The current FRH, while effective for its intended purpose, produces hydrogen gas as a byproduct, generating safety, transportation, storage and disposal concerns, and making it less suitable for use in consumer sector applications where accidental misuse could lead to fire or explosion.

Also, the water required for reaction, in addition to being heavy and spacious, is typically obtained from a supply of drinking water, which can be limited. Further, the step of adding the water can also be an inconvenient additional step in the process of activating the FRH.

Self-heating food packaging products are also available in the consumer market. These products use the heat of hydration from mixing “quicklime” (calcium oxide) and water (CaO+H₂O→Ca(OH)₂) which does not generate hydrogen. With water present the peak temperature is similarly limited to 212° F. However, even neglecting the weight of packaging and water, the specific energy of the system is low (approximately 1.2 kJ per gram of CaO).

These and other self-contained systems must also provide some means of mixing the segregated reactants adding further complexity and bulk. Measurements on some commercial self-heating packaged food products are shown in Table 1.

TABLE 1

| | Food product (net) | | Total package (gross) | | Specific |
|---|---|---|---|---|---|
| | Weight | Volume | Weight | Volume | energy of |
| | (g) | (ml) | (g) | (ml) | heater (kJ/g) |
| Coffee | 300 | 295 | 551 | 600 | 0.34 |
| Beef stew | 425 | 481 | 883 | 963 | 0.13 |

While quicklime based heaters may offer greater safety than the magnesium based heaters, quicklime heaters have significantly lower specific energy. Further, an increase in the weight and size of the heater (needed to compensate for the low specific energy) causes the heater to approach the size and weight of the object being heated. This reduces portability of such heaters.

In addition to the water-based heaters described above, it is known to utilize oxygen-based heaters. Oxygen-based heaters, such as those described in U.S. Pat. Nos. 5,984,995, 5,918,590 and 4,205,957, have certain benefits over water-based heaters.

First, oxygen-based heaters do not require the addition of water to generate heat. Second, because oxygen-based heaters generate heat only in the presence of oxygen, the exothermic reaction can be stopped by simply preventing oxygen access. In addition, such heaters allow for the exothermic reaction to be restarted at a later time by re-introducing oxygen. Furthermore, since oxygen is abundant in the atmosphere, these heaters do not require mixing of components.

The assignee of the present invention has provided oxygen-base heaters and various packages for same. See, e.g., U.S. patent application Ser. Nos. 12/376,927 and 12/874,338 (filed on Feb. 9, 2009 and Sep. 2, 2010, respectively) both of which are incorporated herein by reference in their entirety; see also, U.S. patent application Ser. Nos. 11/486,400 and 12/711,963 (filed on Jul. 12, 2006 and Feb. 24, 2010, respectively) both of which are incorporated herein by reference in their entirety. These disclosed heaters and packages are successful at providing an oxygen based heater and/or package for same.

However, there are benefits that can be obtained from improving such heaters and packages. These benefits can provide for more efficient heaters, better packaging, easier manufacturing, and lower manufacturing costs.

The present invention is directed to providing improvements to these types of heaters to achieve these, as well as other, benefits.

### SUMMARY OF THE INVENTION

In one aspect of the present invention, the present invention is directed towards various electrolyte solution formulations used with an oxygen based heater.

In another aspect of the present invention, the present invention is directed towards a method of manufacturing a heater and the electrolyte solution formulations used with same.

In order to sustain the exothermic reaction, these types of oxygen based heaters require the presence of an electrolyte solution. It is has been determined that the properties of the electrolyte(s) in the electrolyte solution can have an affect on the characteristics of the heater.

For example, by selecting the appropriate electrolyte(s) it is possible to control the maximum heater temperature. Specifically, it is possible to engineer a heater that has a specific maximum temperature based upon the selection of one or more electrolytes that create an electrolyte solution with appropriate boiling points. As the temperature of the heater reaches the boiling point(s) of the electrolyte solution(s), the temperature will plateau as the electrolyte solution boils off As the amount of available electrolyte solution decreases, the amount of heat generated will decrease and the temperature will begin to fall. At some point the amount of electrolyte solution will fall below the level required to maintain the reaction and no further heat is generated.

In addition to controlling the maximum temperature, the vapor pressure (or relative humidity) of the electrolyte solution can influence the shelf life of the heaters. Specifically, an electrolyte with too high of a vapor pressure/relative humidity can lower the shelf life of the heater because the high internal vapor pressure/relative humidity can cause the some of the water molecules of the electrolyte solution to evaporate through the sealed package. As discussed above, sufficient loss of water will cause the exothermic reaction to stop. However, too low of a vapor pressure/relative humidity inside the heater may cause the electrolyte solution to dilute based upon the migration of water from the atmosphere into the package, leading to a reduction in heating performance.

In addition to the above control of shelf life based upon the vapor pressure/relative humidity of the electrolyte solution, it is contemplated that the shelf life can be extended by including additional electrolyte. In other words, the manufacturing process can account for the loss of electrolyte by adding additional electrolyte solution so that if some of the water evaporates, a sufficient amount remains in the heater for use.

In addition to the boiling point and vapor pressure/relative humidity of the electrolyte, it is thought that the solubility of the resulting hydroxide and the reactivity of the cation are also factors to consider in selecting the electrolyte.

To this end, certain embodiments of the present invention provide an oxygen based heater with a predetermined maximum temperature that is based upon an electrolyte solution. In addition, certain embodiments of the present invention provide an oxygen based heater with a predetermined shelf life that is based upon an electrolyte solution. The solution may include one or more different electrolyte chemicals, and specifically, may include potassium bromide, potassium iodide, sodium bromide, and/or sodium iodide.

It is to be understood that the aspects and objects of the present invention described above may be combinable and that other advantages and aspects of the present invention will become apparent to those having ordinary skill in the art upon reading the following description of the drawing and the detailed description thereof.

### BRIEF DESCRIPTION OF THE DRAWINGS

The present invention will become more fully apparent from the following description and appended claims, taken in conjunction with the accompanying drawings. Understanding that the accompanying drawings depicts only typical embodiments, and is, therefore, not to be considered to be limiting of the scope of the present disclosure, the embodiments will be described and explained with specificity and detail in reference to the accompanying drawings as provided below.

FIG. 1 is a front perspective view of the oxygen based heater in a package used with the electrolytes of the present invention.

FIG. 2 is a top cut away view of an oxygen based heater taken along line A in which a pad has been provided.

### DETAILED DESCRIPTION OF EMBODIMENTS OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

Reference throughout this description to features, advantages, objects or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, any discussion of the features and advantages, and similar language, throughout this specification may, but does not necessarily, refer to the same embodiment.

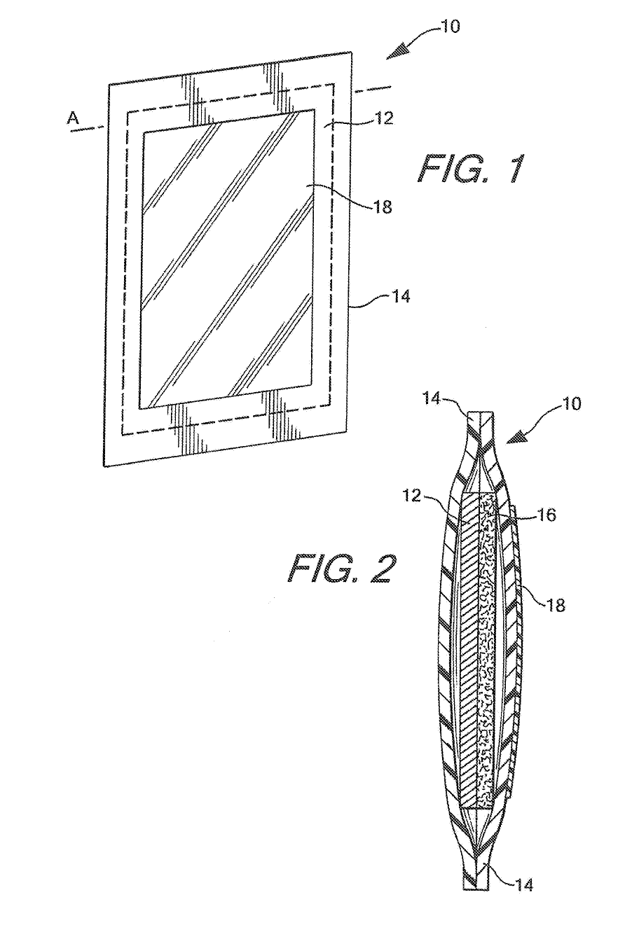

As shown in FIGS. 1 and 2, heater 10 generally includes heater substrate 12 (shown in dashed lines in FIG. 1) in package 14.

Heater substrate 12 exothermically reacts with oxygen (preferably atmospheric oxygen). Accordingly, heater substrate 12 may include at least a reducing agent, such as aluminum or zinc, and a binding agent, such as polytetrafluoroethylene or a polyolefin. One of ordinary skill in the art will appreciate that other chemicals can be used or included to make heater substrate 12. The term “substrate” means that heater substrate 12 is a solid object, and not merely a mass of powdered chemicals.

Package 14 typically includes seal 18 (such as a flap). It is preferred that seal 18 is re-attachable (or otherwise able to close the package to stop the production heat so that heater 10 can be re-used), but at a minimum seal 18 is removable allowing for oxygen access to heater substrate 12 to be restricted until seal 18 is removed from package 14.

In order to produce a sustained exothermic reaction these types of heaters 10 require an electrolyte solution. The electrolyte solution may be impregnated on pad 16 disposed adjacent heater substrate 12. See, FIG. 2. Pad 16 may be a non-woven material such as a blend of polyester and cellulose fibers, polypropylene fibers, or other suitable non-woven polymeric material.

At least one of the electrolytes in the electrolyte solution is selected based upon its relative humidity and/or its boiling point. If the relative humidity inside of the package is too high (higher than the relative humidity of the surrounding atmosphere), as the product is stored, water from the electrolyte will be lost to the environment. Conversely, if the relative humidity is lower than the surrounding atmosphere, water from the atmosphere will migrate into the package.

In order to select the appropriate electrolytes, a maximum temperature of 56 degrees Celsius was determined to be an initial goal predetermined temperature (however, other temperatures may be selected based upon the use of the heater). In addition, a relative humidity goal of 40%-50% at 25° C. and a relative humidity goal of approximately 50% at 80° C. were used as initial values to provide an initial pre-determined shelf life between 6 months to 3 years and more specifically (again, one of ordinary skill in the art will appreciate that other values can be used) between one to two years. Also, as would be appreciated by one of ordinary skill in the art, the material of the package will have an impact on the design of the system as different materials have different water vapor transmission rates, and thus, in addition to the relative humidity, one of ordinary skill in the art will appreciate that the selection of the electrolyte and the determination of a desired shelf-life may also take into account the material of the package for the heater.

The following table provides some results of experiments.

TABLE 2

| | ΔT_{5 min} | ΔT | Time to Peak | RH at | RH at |
|---|---|---|---|---|---|
| Electrolyte Solution | (° C.) | (° C.) | Temp | 25° C. | 80° C. |
| 50% KOH | 56.4 | 59.1 | 7 min | 8-9% | <5% |
| KCl (saturated) | 41.2 | 48.2 | 8 min | 84% | 79% |
| NaCl (saturated) | 34.8 | 51.6 | 10 min | 75% | 76% |
| KBr (saturated) | 49.2 | 55.3 | 8 min | 81% | 79% |
| KI (saturated) | 40.7 | 52.4 | 8 min | 69% | 60% |
| KCl | 35.5 | 50.9 | 8 min | 84% | 79% |
| Kl | 46.7 | 53 | 7.5 min | 69% | 60% |
| Goals | — | 56 | 5 min | 40-50% | Est 50% |

The above goals were selected to meet the heating and the shelf life requirements for various products across multiple disciplines and thus are merely used to demonstrate the principles of one or more various embodiments of the present invention. The humidity data is based upon an article by Lewis Greenspan entitled “Humidity Fixed Points of Binary Saturated Aqueous Solutions,” from Journal of Research of the National Bureau of Standards.

As can be seen in the data from Table 2, an electrolyte of 50% potassium hydroxide has a relative humidity of approximately 8-9%—meaning that water lost to the atmosphere should not be an issue for such an electrolyte. However, given the basic nature of the electrolyte, it can be desirable to rely on a more neutral or less caustic electrolyte solution that is safe for human handling and interaction with or near food electrolyte solution.

Based upon the data in Table 2, potassium bromide was selected as an electrolyte and various concentrations were tested. The concentrations and results of the test are shown in Table 3, below.

TABLE 3

| | KBr | | Electrolyte Amount | Initial | 5 min. | Max | Time to |
|---|---|---|---|---|---|---|---|
| | Concentration | RH % | by Heater | Temp | Temp | Temp | Max Temp |
| Group | (%) | (25° C.) | Weight (%) | (° C.) | (° C.) | (° C.) | (min) |
| A | 20.0% | 90.0% | 35% | 23.1 | 51.3 | 54.0 | 7.42 |
| B | 28.5% | 85.0% | 35% | 22.8 | 51.1 | 52.5 | 7.08 |
| C | 40.0% | 81.0% | 35% | 22.1 | 48.2 | 50.3 | 7.57 |

As can be seen, since Group C provided a relatively low relative humidity, providing a sustained shelf life. However, because the concentration of the electrolyte in the solution, as water evaporates and leaves the package, KBr will precipitate on the substrate. This is undesirable as it will negatively impact the ability of the heater to react with oxygen and thus, produce heat.

As also shown ion TABLE 3, a smaller concentration of KBr (Group B) provided a somewhat higher relative humidity—but one that would be in an acceptable range for the desired shelf life. Additionally, due to the lower concentration, there is a lower occurrence of the electrolyte precipitating onto the substrate due to evaporation of water.

It is also contemplated that potassium iodide could act as an appropriate electrolyte in the electrolyte solution and would provide a higher maximum temperature than an electrolyte solution having only potassium chloride (or sodium chloride). However, it is believed that potassium iodide is more expensive than potassium bromide and less effective. Nevertheless, it is still contemplated to be an acceptable material to engineer an electrolyte solution for a specific relative humidity.

Furthermore, it is believed that sodium bromide and sodium iodide would have similar temperature and relative humidity properties to potassium iodide and potassium bromide given their common anions and similar cation properties. Thus, in one embodiment of the present invention, the electrolyte solution includes at least one electrolyte selected from the group consisting of: potassium bromide; potassium iodide; sodium bromide; and, sodium iodide. It is also contemplated that other metal halide salts (such as Li, Mg, Na, Zn, Cs, or Al combined with Cl, Br, or I) be utilized, alone or in combination with the previously discussed electrolytes. Furthermore, the electrolyte solution may also include relative humidity modifiers, like a glycerol.

In another embodiment of the invention, the electrolyte chosen creates an electrolyte solution that has at least a relative humidity at 25° C. between 60% to 85%. The solution may also have a relative humidity at 80° C. between 60% to 79%. The heater may also have a maximum temperature of at least 50° C. However, it is contemplated that the heater has a different maximum temperature based upon the intended use of the heater. For example, it is contemplated that the heater has a maximum temperature below the ignition temperature of paper (approximately 231° C.) and/or a maximum temperature below the boiling point of the electrolyte solution. Additionally, in some applications it is contemplated that the heater have a maximum temperature of 60° C. which is thought to be a maximum temperature when the heater is associated with human interaction.

In yet another aspect of the invention, the present invention provides various methods of making a heater. These methods generally include the steps of providing a substrate heater, providing an electrolyte solution to the heater substrate, and sealing the heater substrate.

In one embodiment, the present invention provides a method that includes the step of selecting the electrolyte solution based upon the relative humidity of the electrolyte solution.

In another embodiment, the present invention provides a method that includes the step of selecting the electrolyte solution based upon the boiling point of the electrolyte solution.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is claimed is:

1. A heater comprising:
a substrate that produces heat, in the presence of oxygen; and,
an electrolyte solution;
wherein the electrolyte solution has a relative humidity at 25° C. between 60% to 85%.

2. The heater of claim 1 wherein the electrolyte solution contains more than one electrolyte.

3. The heater of claim 1 wherein the electrolyte solution includes at least one electrolyte that is a metal halide salt.

4. The heater of claim 3 wherein the metal halide salt is selected from the group consisting of potassium bromide; potassium iodide; sodium bromide; and sodium iodide.

5. The heater of claim 1 further comprising a package surrounding the substrate and electrolyte solution.

6. The heater of claim 5 further comprising a pad adjacent to and in contact with the substrate.

7. The heater of claim 1 further comprising the heater having a maximum temperature of approximately 231° C. or below.

8. The heater of claim 1 wherein the heater has a shelf life between six months to three years.

9. A method of making a heater comprising the steps of:
providing a substrate heater;
determining a relative humidity of an electrolyte solution;
providing the electrolyte solution to the heater substrate only if the relative humidity of the electrolyte solution is capable of meeting a pre-determined shelf life; and,
sealing the heater substrate in a package.

10. The method of claim 9 wherein the electrolyte is selected from the group consisting of: potassium bromide; potassium iodide; sodium bromide; and sodium iodide.

11. The method of claim 9 wherein the electrolyte solution has a relative humidity at 25° C. between 60% to 85%.

12. The method of claim 9 wherein the pre-determined shelf life is between six months to three years.

13. The method of claim 9 wherein the electrolyte solution includes at least one electrolyte that is a metal halide salt.

14. The method of claim 13 wherein the heater has a maximum temperature of approximately 231° C. or below.

15. A method of making a heater comprising the steps of:
providing a substrate heater,
selecting an electrolyte solution based upon the boiling point of the electrolyte solution,
providing the electrolyte solution to the heater substrate, and
sealing the heater substrate in the package.

16. The method of claim 15 wherein the electrolyte is selected from the group consisting of potassium bromide; potassium iodide, sodium bromide; and sodium iodide.
